(19) United States
(12) Patent Application Publication
(10) Pub. No.: US 2026/0023212 A1
(43) Pub. Date: Jan. 22, 2026

(54) OPTICAL FIBER, OPTICAL FIBER PREFORM, AND METHOD OF MANUFACTURING OPTICAL FIBER

(71) Applicant: Lightera Japan Co.,Ltd., Tokyo (JP)

(72) Inventors: Kazunori MUKASA, Tokyo (JP); Osanobu FUKUO, Tokyo (JP); Tomoya AKAO, Tokyo (JP)

(73) Assignee: Lightera Japan Co.,Ltd., Tokyo (JP)

(21) Appl. No.: 19/273,744

(22) Filed: Jul. 18, 2025

(30) Foreign Application Priority Data
Jul. 22, 2024 (JP) 2024-117161
Jun. 23, 2025 (JP) 2025-105433

(51) Int. Cl. G02B 6/036; C03B 37/012; C03B 37/03; G02B 6/02

(52) U.S. Cl. CPC G02B 6/03694; C03B 37/012; C03B 37/032; G02B 6/02361

(57) ABSTRACT

An optical fiber includes: an inner portion including a core portion and an inner cladding portion that surrounds the core portion and has a refractive index lower than a maximum refractive index of the core portion; and an outer layer surrounding the inner portion. A pressurizing section is provided between the inner portion and the outer layer, the pressurizing section being capable of applying pressure to the inner portion when being applied with pressure from external, and the inner portion has an average viscosity lower than an average viscosity of the outer layer.

This application claims the benefit of priority from Japanese Patent Application No. 2024-117161 filed on Jul. 22, 2024 and Japanese Patent Application No. 2025-105433 filed on Jun. 23, 2025, the entire contents of which are incorporated herein by reference.

### BACKGROUND

The present disclosure relates to an optical fiber, an optical fiber preform, and a method of manufacturing an optical fiber.

As a method for reducing the transmission loss of optical fibers, there is a method for using vitreous silica to which fluorine is added, as the material of the cladding portion, and using pure vitreous silica or vitreous silica containing an extremely small amount of dopant, as the material of the core portion, and active discussions are currently being done.

The main factor of the transmission loss in optical fibers is Rayleigh scattering loss. A major factor of Rayleigh scattering loss is extremely small density fluctuations in the glass, mainly, in the glass forming the core portion. One example of methods for controlling such density fluctuations includes controlling the viscosity of the glass using the material of core dopant. Other methods include controlling the fictive temperature of the glass by introducing drawing conditions and/or an annealing furnace. A number of reports have been made on this subject, and a transmission loss at a level of 0.14 dB/km or so has been achieved, as an example. As another method, there is a method for suppressing formation of large voids, which account for a major part of the density fluctuations in the glass forming, by applying pressure to the glass during the glass transition, in the process of drawing the optical fiber from an optical fiber preform (see M. Ono, S. Aoyama, M. Fujinami, and S. Ito, “Significant suppression of Rayleigh scattering loss in silica glass formed by the compression of its melted phase,” Optics Express, vol. 26, pp. 7942-7948, 2018).

### SUMMARY

As described above, reduction of transmission loss in an optical fiber is important.

There is a need for optical fibers with lower transmission loss and an optical fiber preform, and a method of manufacturing the optical fibers.

According to one aspect of the present disclosure, there is provided an optical fiber including: an inner portion including a core portion and an inner cladding portion that surrounds the core portion and has a refractive index lower than a maximum refractive index of the core portion; and an outer layer surrounding the inner portion, wherein a pressurizing section is provided between the inner portion and the outer layer, the pressurizing section being capable of applying pressure to the inner portion when being applied with pressure from external, and the inner portion has an average viscosity lower than an average viscosity of the outer layer.

According to another aspect of the present disclosure, there is provided an optical fiber preform including: an inner portion including a core portion and an inner cladding portion that surrounds the core portion and has a refractive index lower than a maximum refractive index of the core portion; and an outer layer surrounding the inner portion, wherein a pressurizing section is provided between the inner portion and the outer layer, the pressurizing section being capable of applying pressure to the inner portion when being applied with pressure from external, and the inner portion has an average viscosity lower than an average viscosity of the outer layer.

### BRIEF DESCRIPTION OF THE DRAWINGS

FIG. 1 is a schematic cross-sectional view of an optical fiber according to a first embodiment, across a plane perpendicular to the longitudinal direction of the optical fiber;

FIG. 2 is a schematic cross-sectional view of an optical fiber preform used in manufacturing the optical fiber illustrated in FIG. 1, across a plane perpendicular to the longitudinal direction of the optical preform;

FIG. 3 is a schematic for explaining a process of drawing an optical fiber from the optical fiber preform;

FIG. 4 is a graph representing one example of a relation between a ratio of the thickness of an outer layer to the radius of an inner portion, and non-circularity of the optical fiber; and

FIG. 5 is a graph representing one example of a relation between reduction in the relative refractive-index difference due to the concentration of K in the core portion and F in the inner cladding portion, and improvements in the transmission loss.

### DETAILED DESCRIPTION

An embodiment will now be explained in detail, with reference to drawings. The embodiment described below is not intended to limit the scope of the present disclosure in any way. In the drawings, identical or corresponding components are given the same reference numerals as appropriate, and redundant explanations thereof will be omitted. The terms not defined herein are in accordance with the definitions and measurement methods as stipulated in ITU-T G. 650.1 and G. 650.2 of the International Telecommunication Union (ITU).

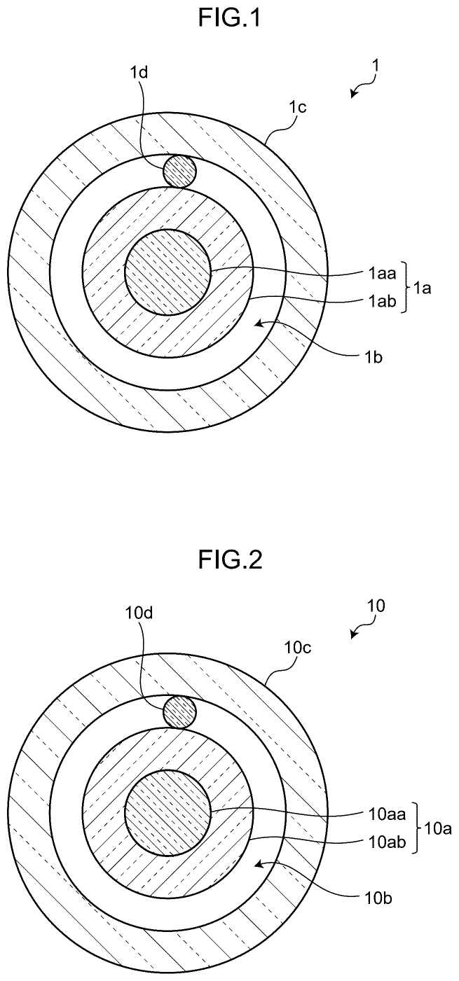

FIG. 1 is a schematic cross-sectional view of an optical fiber according to a first embodiment, across a plane perpendicular to the longitudinal direction of the optical fiber. The optical fiber 1 includes an inner portion 1a and an outer layer 1c.

The inner portion 1a includes a core portion 1aa and an inner cladding portion lab. The core portion 1aa is made of vitreous silica containing, for example, at least one of potassium (K) and sodium (Na). Without limitation thereto, the constituent material of the core portion 1aa may also be pure vitreous silica, for example. Pure vitreous silica is extremely high-purity vitreous silica containing substantially no dopant causing a change in the refractive index, and having a refractive index of approximately 1.444 for the light at the wavelength of 1550 nm. The pure vitreous silica used for the components of the optical fiber 1 may sometimes contain some chlorine or the like used in the manufacturing process.

The inner cladding portion lab is disposed in a manner surrounding the core portion. The inner cladding portion lab has a refractive index lower than the maximum refractive index of the core portion 1aa. The inner cladding portion lab is made of vitreous silica to which a dopant lowering the refractive index is added, such as fluorine.

The outer layer 1c is a tube-like part surrounding the inner portion 1a. The outer layer 1c is made of pure vitreous silica, for example. The outer layer 1c may also be made of vitreous silica to which a dopant lowering the refractive index is added, such as fluorine. In such a case, the inner cladding portion lab contains more fluorine than the outer layer 1c does, for example.

A pressurizing section 1b is provided between the inner portion 1a and the outer layer 1c. The pressurizing section 1b may apply pressure to the inner portion 1a when being applied with pressure from the external. In this embodiment, the pressurizing section 1b is hollow. The optical fiber 1 is also provided with a fixing portion 1d. The fixing portion 1d is welded to the outer circumferential surface of the inner portion 1a and the inner circumferential surface of the outer layer 1c, to fix the inner portion 1a and the outer layer 1c to each other. In this embodiment, the fixing portion 1d is a rod-like portion having a circular cross section. The fixing portion 1d is made of pure vitreous silica, for example, but may be made of any vitreous silica without limitation thereto. In this embodiment, one fixing portion is provided, but a plurality of the fixing portions may also be provided. In such a case, it is preferable for the fixing portions to be provided at equal angles about the central axis of the optical fiber. One example of the number of fixing portions is three or more.

In the optical fiber 1, the inner portion 1a has an average viscosity lower than the average viscosity of the outer layer 1c. The average viscosity of the inner portion 1a is defined as (AX+BY)/(X+Y) (Pa·s), denoting the viscosity of the core portion 1aa as A (Pa·s); a cross-sectional area of the core portion 1aa in a direction orthogonal to the longitudinal direction of the optical fiber 1 as X (μm²); the viscosity of the inner cladding portion lab as B (Pa·s); and denoting the cross-sectional area of the inner cladding portion lab in a direction orthogonal to the longitudinal direction of the optical fiber 1 as Y (μm²).

It is assumed herein that, as an example, the outer layer 1c is made of pure vitreous silica, and the inner cladding portion lab is made of vitreous silica to which fluorine is added so as to exhibit a relative refractive-index difference of −0.4% with respect to the relative refractive index of pure vitreous silica. Under these assumptions, the outer layer 1c exhibits a viscosity of 3×10¹¹ Pas at 1200° C., and the inner cladding portion lab exhibits a viscosity of 4×10¹⁰ Pa·s at 1200° C. The temperature 1200° C. herein is a temperature reached by the optical fiber 1 when the optical fiber 1 is and softened during the manufacturing process (drawing process). In these settings, the optical fiber 1 with the core portion 1aa made of pure vitreous silica satisfies the condition for the average viscosity of the inner portion 1a to be lower than the average viscosity of the outer layer 1c. Furthermore, when a core portion 1aa is made of vitreous silica containing at least one of potassium and sodium, the optical fiber 1 satisfies the condition for the average viscosity of the inner portion 1a to be lower than the average viscosity of the outer layer 1c, because the core portion 1aa has a viscosity even lower than that of the core made of pure vitreous silica. Representing the average viscosity of the outer layer 1c at 1200° C. as one, the average viscosity of the inner portion 1a at 1200° C. is 0.9 or less, for example.

With the optical fiber 1 configured as described above, by applying pressure to the inner portion 1a via the pressurizing section 1b during the manufacturing process, it is possible to suppress a density fluctuation in the glass forming a part where the light propagates (mainly the core portion 1aa), so that the transmission loss is further reduced. Moreover, with the optical fiber 1, because the average viscosity of the inner portion 1a is set lower than the average viscosity of the outer layer 1c, the effect of suppressing the density fluctuation may be more effectively given to the inner portion 1a. As a result, the transmission loss is further reduced. Preferably, the core portion 1aa of the optical fiber 1 achieves a transmission loss of 0.15 dB/km or less for the light at the wavelength of 1550 nm.

The optical fiber 1 may be manufactured in the following manner, for example. To begin with, an optical fiber preform from which the optical fiber 1 is manufactured is prepared. FIG. 2 is a schematic cross-sectional view of an optical fiber preform across a plane perpendicular to the longitudinal direction of the optical preform used in manufacturing the optical fiber 1.

An optical fiber preform 10 illustrated in FIG. 2 has the same cross-sectional structure as that of the optical fiber 1. In other words, the optical fiber preform 10 includes an inner portion 10a including a core portion 10aa and an inner cladding portion 10ab, an outer layer 10c, and a fixing portion 10d. Furthermore, a hollow pressurizing section 10b is provided between the inner portion 10a and the outer layer 10c. The hollow pressurizing section 10b may apply pressure to the inner portion 10a when being applied with pressure from the external. The constituent materials of the components in the optical fiber preform 10 are the same constituent materials as those of the corresponding components in the optical fiber 1. For example, when the core portion 1aa is made of vitreous silica containing potassium, the core portion 10aa is also made of vitreous silica containing potassium. Therefore, the inner portion 10a has an average viscosity lower than average viscosity of the outer layer 10c.

The optical fiber preform 10 may be manufactured by preparing the inner portion 10a, the outer layer 10c, and the fixing portion 10d, and by welding these components by heating with oxyhydrogen flame. The optical fiber preform 10 may be manufactured easily by aligning the inner portion 10a, the outer layer 10c, and the fixing portion 10d using a jig for alignment.

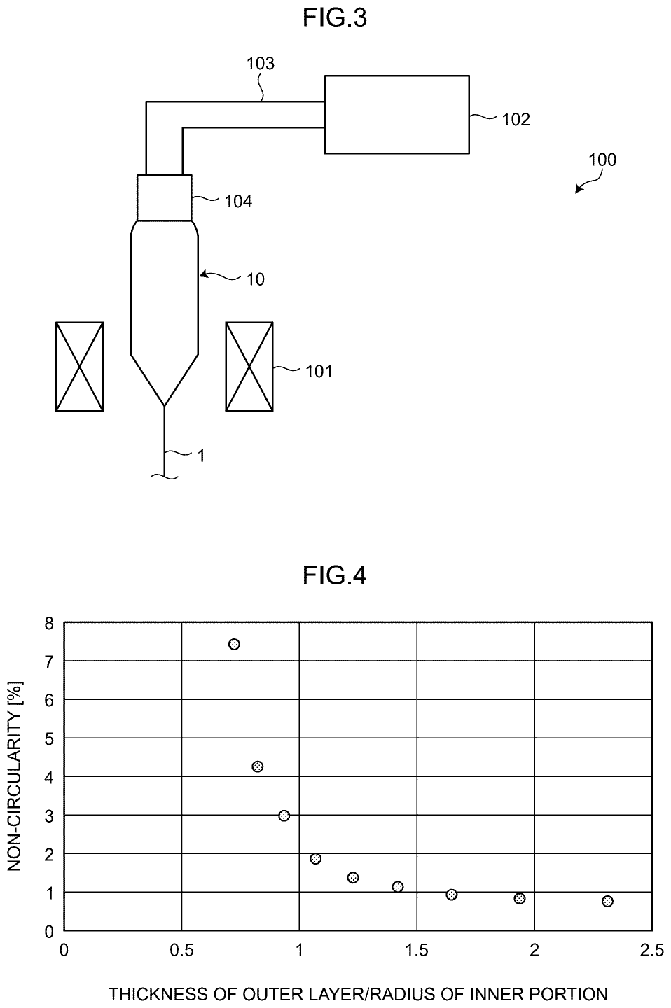

The optical fiber preform 10 is then drawn to manufacture the optical fiber 1. FIG. 3 is a schematic for explaining a process of drawing an optical fiber from the optical fiber preform 10.

In the process of drawing an optical fiber, the optical fiber preform 10 is placed in a drawing furnace of a fiber pulling machine 100, and one end of the optical fiber preform 10 is heated and softened by a heater 101 in the drawing furnace, and the optical fiber 1 is drawn downwards in the vertical direction. At this time, a pressurizing device 102 is connected to the upper end of the optical fiber preform 10, via a pipe 103 and a connecting jig 104. While the optical fiber is being drawn, the pressurizing device 102 keeps sending inert gas such as N₂ or Ar into the pressurizing section 10b of the optical fiber preform 10. By applying pressure (e.g., 10000 Pa or higher) to the pressurizing section 10b from the external in the manner described above, the optical fiber 1 may be drawn while the inner portion 10a is being pressurized. At this time, because the inner portion 10a of the optical fiber preform 10 has an average viscosity lower than the average viscosity of the outer layer 10c, the inner portion 10a is pressurized more effectively than the outer layer 10c. In this manner, it is possible to suppress the density fluctuation in the inner portion 10a, effectively.

During the process of drawing the optical fiber, it is preferable to optimize the pressurizing conditions so as to bring these values to the desirable values with the outer diameter or the non-circularity of the optical fiber being monitored.

Preferable characteristics of the optical fiber according to the embodiment will now be explained. The inventor of the present disclosure conducted research on how the ratio of the thickness of the outer layer of the optical fiber to the radius of the inner portion affects the non-circularity of the optical fiber. For the purpose of this research, an optical fiber preform was manufactured that had the same basic structure as that of the optical fiber preform 10 but different in including four fixing portions 10d provided at equal angles about the central axis. The cross section of the manufactured optical fiber preform on a plane in a direction orthogonal to the longitudinal direction had a radius of 8 mm to 30 mm. In this optical fiber, the core portion was made of vitreous silica to which only 100 ppm of potassium is added, and the inner cladding portion was made of vitreous silica having fluorine added thereto so as to exhibit a relative refractive-index difference of −0.4% with respect to the relative refractive index of pure vitreous silica. The fixing portions and the outer layer were made of pure vitreous silica. The thickness of the outer layer was set to 3 mm to 16 mm, and the thickness of the pressurizing section was set to a half of the thickness of the outer layer.

An optical fiber was then manufactured by drawing from the optical fiber preform manufactured in the manner described above while the optical fiber preform is being pressurized in the manner explained with reference to FIG. 3, and non-circularity of a cross section perpendicular to the longitudinal direction of the optical fiber was obtained. For the purpose of comparison, another optical fiber was manufactured by drawing without pressurizing, and the non-circularity of a cross section perpendicular to the longitudinal direction of the manufactured optical fiber was obtained. It was confirmed that the potassium added to the core portion was dispersed across the inner cladding portion, to some extent, as a result of heating at the time of drawing the optical fiber.

FIG. 4 is a graph representing one example of a relation between a ratio of the thickness of the outer layer to the radius of the inner portion, and the non-circularity of the optical fiber. The data illustrated in FIG. 4 represents selection of data of optical fibers having achieved reductions of 0.01 dB/km or more, with respect to the transmission loss of the optical fiber manufactured without pressurizing, at 1550 nm. As illustrated in FIG. 4, when the ratio is lower, the non-circularity increased. A ratio of 1 or higher is preferable because non-circularity of 2% or less may be achieved; a ratio of 1.5 or higher is more preferable because non-circularity of 1% or less may be achieved; and a ratio of 2 or higher is even more preferable because not only the non-circularity of 1% or less may be achieved but also a change in the non-circularity with respect to a change in the ratio is stabilized.

Furthermore, according to the experiment carried out by the inventor of the present disclosure, it has been found that three or more fixing portions 1d are preferable for the stability of the non-circularity.

Next, the ratio of the thickness of the outer layer to the radius of the inner portion was fixed at 1.5, and changes in the transmission loss in the optical fiber were examined at the wavelength of 1550 nm, through simulating computations and experiments, when the potassium concentration in the core portion and fluorine concentration in the inner cladding portion were variously changed. The optical fibers used were those having the same basic structure as that of the optical fiber 1, but were different in including four fixing portions 1d that are provided at equal angles about the central axis. The thickness of the pressurizing section was set to a half of the thickness of the outer layer. For the experiments, optimal drawing conditions were used.

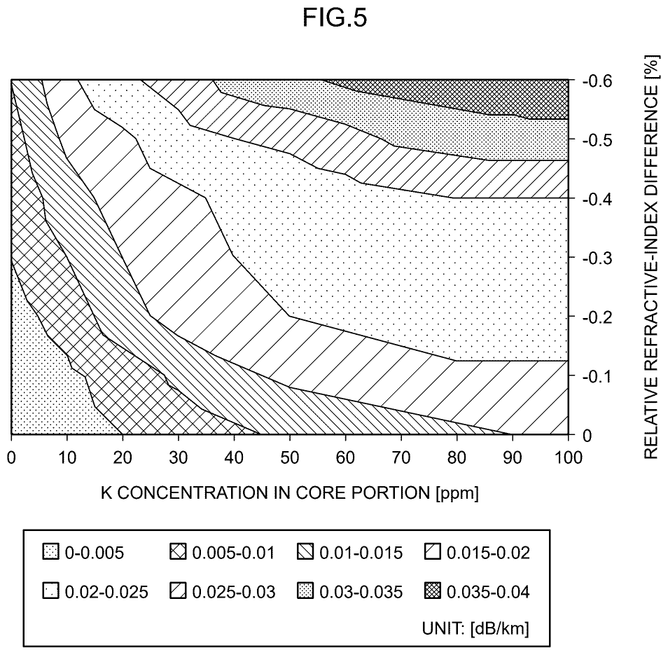

FIG. 5 is a graph representing one example of a relation between reduction in the relative refractive-index difference due to the concentration of K (potassium) in the core portion and F (fluorine) in the inner cladding portion, and improvements in the transmission loss. The amount of improvement in the transmission loss is the amount by which the transmission loss was reduced at the wavelength of 1550 nm, with respect to the transmission loss in the optical fiber manufactured without the pressurizing, and the unit is [dB/km].

As illustrated in FIG. 5, it has been confirmed that the improvements of 0.01 dB/km or more were achieved, when the reduction in the relative refractive-index difference (hereinafter simply referred to as reduction) is-0.6% or less, with a K concentration of 0 ppm; when the reduction is-0.3% or less, with a K concentration of 10 ppm or so; when the reduction is-0.15% or less, with a K concentration of 20 ppm or so; when the reduction is-0.08% or less, with a K concentration of 30 ppm or so; when the reduction is-0.02% or less, with a K concentration of 40 ppm or so; and when the reduction is 0% (that is, without any addition F), with a K concentration of 45 ppm or so.

In the optical fiber according to the embodiment, although the outer diameter of the outer layer is, for example, 125 μm, the outer layer preferably has an outer diameter of 250 μm or less, from the viewpoint of the mechanical reliability.

Furthermore, in the optical fiber according to the embodiment, the effective core area (Aeff) of the core is 170 μm² or less, from the view point of suppressing an increase in the transmission loss due to the effect of microbending loss.

Furthermore, the optical fiber according to the embodiment is preferably a single-mode optical fiber from the view point of suppressing an increase in the transmission loss due to the effect of the higher-order modes. However, there is no limitation thereto, and the effect of reducing the transmission loss, exerted by suppressing density fluctuation, may also be achieved in multi-mode optical fibers.

Furthermore, it is preferable for the optical fiber according to the embodiment to satisfy the characteristics of the optical fiber stipulated in ITU-T G. 652 or recommendations related thereto.

Furthermore, the optical fiber and the optical fiber preform according to the embodiment each have a hollow pressurizing section, but the pressurizing section may be configured in any way as long as the pressurizing section may apply pressure to the inner portion when being applied with pressure from the external, without limitation to any particular configuration. For example, the pressurizing section may be porous glass allowing pressurizing gas to pass, or solid medium the volume of which swells by being heated. In some of such cases, the fixing portions may be unnecessary.

The embodiment described above is not intended to limit the scope of the present disclosure in any way. Any configuration including appropriate combinations of the components described above fall within the scope of the present disclosure. For example, in the first embodiment, the inner portion has a stepped refractive index profile, but may be replaced with any refractive index profile applicable to optical fibers, such as trench profile or a W profile. Those skilled in the art may easily come up with any other effects and modifications. Therefore, a broader configurations of the present disclosure is not limited to the embodiment described above, and various changes remain possible.

According to the present disclosure, it is possible to achieve optical fibers with lower transmission loss, advantageously.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical fiber comprising:
an inner portion including a core portion and an inner cladding portion that surrounds the core portion and has a refractive index lower than a maximum refractive index of the core portion; and
an outer layer surrounding the inner portion, wherein
a pressurizing section is provided between the inner portion and the outer layer, the pressurizing section being capable of applying pressure to the inner portion when being applied with pressure from external, and
the inner portion has an average viscosity lower than an average viscosity of the outer layer.

2. The optical fiber according to claim 1, wherein
the pressurizing section is hollow, and
the optical fiber further comprises a fixing portion that fixes the inner portion and the outer layer to each other.

3. The optical fiber according to claim 1, wherein the core portion is made of vitreous silica containing at least one of potassium and sodium.

4. The optical fiber according to claim 1, wherein the inner cladding portion contains more fluorine than the outer layer does.

5. The optical fiber according to claim 1, wherein the core portion achieves a transmission loss of 0.15 dB/km or less for light at a wavelength of 1550 nm.

6. The optical fiber according to claim 1, wherein a ratio of a thickness of the outer layer to a radius of inner portion is 1 or higher.

7. The optical fiber according to claim 1, wherein a ratio of a thickness of the outer layer to a radius of inner portion is 1.5 or higher.

8. The optical fiber according to claim 1, wherein a ratio of a thickness of the outer layer to a radius of inner portion is 2 or higher.

9. An optical fiber preform comprising:
an inner portion including a core portion and an inner cladding portion that surrounds the core portion and has a refractive index lower than a maximum refractive index of the core portion; and
an outer layer surrounding the inner portion, wherein
a pressurizing section is provided between the inner portion and the outer layer, the pressurizing section being capable of applying pressure to the inner portion when being applied with pressure from external, and
the inner portion has an average viscosity lower than an average viscosity of the outer layer.

10. A method of manufacturing the optical fiber according to claim 1, the method comprising:
drawing an optical fiber while pressurizing an inner portion of an optical fiber preform by pressurizing a pressurizing section of the optical fiber preform from an outside,
wherein the optical fiber preform includes:
the inner portion including a core portion and an inner cladding portion that surrounds the core portion and has a refractive index lower than a maximum refractive index of the core portion; and
an outer layer surrounding the inner portion, wherein
the pressurizing section is provided between the inner portion and the outer layer, the pressurizing section being capable of applying pressure to the inner portion when being applied with pressure from external, and
the inner portion has an average viscosity lower than an average viscosity of the outer layer.
